(19) United States
(12) Patent Application Publication
(10) Pub. No.: US 2015/0291745 A1
(43) Pub. Date: Oct. 15, 2015

(54) Self-Healing Polyethylene

(71) Applicant: APPLIED NANOTECH HOLDINGS, INC., Austin, TX (US)

(72) Inventors: Dongsheng Mao, Austin, TX (US); Richard Lee Fink, Austin, TX (US); Zvi Yaniv, Austin, TX (US)

(73) Assignee: PEN INC., Deerfield Beach, FL (US)

(21) Appl. No.: 14/646,484

(22) PCT Filed: Nov. 21, 2013
(86) PCT No.: PCT/US2013/071224

§ 371 Date: May 21, 2015

Related U.S. Application Data
(60) Provisional application No. 61/728,915, filed on Nov. 21, 2012.

(51) Int. Cl. C08J 5/00; C08K 3/00

(52) U.S. Cl. CPC C08J 5/005; C08J 5/00; C08K 3/0033; C08J 2323/06

(57) ABSTRACT

A composite material implements self-healing microcapsules in thermoplastic matrices, such as polyethylene. A microencapsulated dicyclopentadiene monomer and a solid phase Grubbs's catalyst is embedded in a polyethylene matrix to achieve self-healing properties. Nanofillers may be added to improve the properties of the polyethylene matrix incorporating a self-healing system.

This application claims priority to U.S. Provisional Patent Application Ser. No. 61/728,915, which is hereby incorporated by reference herein.

### BACKGROUND AND SUMMARY

The use of thermoplastic pipe systems for gas distribution has been very successful (see, e.g., http://www.pe100plus.net/uploads/library/EFG_Conference_Paper_SHBeech.pdf). These materials, especially polyethylene “PE”) including medium density polyethylene (“MDPE” (density in a range of 0.926-0.941 g/cm³)) and high density polyethylene (“HOPE” (density equal or greater than 0.941 g/cm³)) resins in particular, have become major matrixes for low pressure gas systems, solving the corrosion and reliability issues of steel and ductile iron systems. HDPE is a tough, flexible, lightweight piping product, which can be butt-fused into long, continuous lengths. These unique performance properties combined with exceptional chemical resistance and long term durability make PE pipe a preferred product for a variety of demanding applications.

Today, shipments of PE pressure pipe account for approximately one billion pounds per year for a variety of applications, including gas distribution (see, e.g., http://www.cenews.com/print-magazinearticle-new_ways_to_meet_green_goals-4092.html). PE pressure pipe is produced throughout North America and shipped in sizes ranging from ½″ CTS to 63″ IPS. PE profile pipe for low pressure applications can be provided in sizes up to 144″ in diameter. Improving the following properties of the PE material will lead to wider use and new applications: long term strength, slow crack growth resistance, rapid crack resistance, and tensile strength. Historically, with each advancement in long term strength and tensile strength of HDPE, the gas pressure capability of pipe made from this material has also improved.

Slow crack, growth (“SCG”) is one principal failure mode in PE pressure pipe applications (see, e.g., Min Nie, Shibing Bai, Qi Wang, “High-density polyethylene pipe with high resistance to slow crack growth prepared via rotation extrusion,” Polymer Bulletin 65(6), pp. 609-621 (2010)). This property, also commonly referred to as Environmental Stress Crack Resistance (“ESCR”), is an indicator of the ability of the PE piping material to resist the initiation of slow, slit-type cracks over time in response to long term stress. These cracks, which could, ultimately lead to failure of the piping system, are associated with stresses imposed on the piping product by such phenomena as extreme chemical exposure, excessive growing or scraping, severe temperatures, or irregular loading conditions. If the damage is not detected and repaired, premature failure can occur in the material. Cracks or delaminations also provide sites for ingress of contaminants such as micro-organisms and moisture. Conditions such as moisture ingress significantly reduce the strength of composite structures over time. Thus, the use of PE pipes is limited due to the difficulty in damage detection and repair as well as lack of extended fatigue and impact resistance (see, e.g., Eyassu Woldesenbet and Rochelle Williams, “Self-healing of a single fiber-reinforced polymer matrix composite,” Experimental Analysis of Nano and Engineering Materials and Structures 19, pp. 737-738 (2007)).

### BRIEF DESCRIPTION OF THE DRAWINGS

FIG. 1 illustrates a schematic diagram of an embodiment of the present invention.

FIG. 2 illustrates a schematic diagram of an embodiment of the present invention.

### DETAILED DESCRIPTION

Embodiments of the present invention protect against degradation of the PE matrix through the incorporation of self-healing abilities. Induced by thermal and mechanical fatigue, microcracking is a long-standing problem in PE pipes. If the PE pipes integrated microcapsules filled with a self-healing agent and catalyst, the polymerization of the healing agent, triggered by contact with the embedded catalyst, can bond the crack faces to recover the original, mechanical properties.

The first use of self-healing for a polymer composite was in 1996 (see, e.g., C. Dry, “Procedures Developed for Self-Repair of Polymeric Matrix Composite Materials,” Composite Structures 35, pp. 263-269 (1996)). Dry showed positive results in the feasibility of developing polymer matrix composites that have the ability to self-repair internal cracks caused by mechanical loading. The study focused on the cracking of hollow repair fibers dispersed in a matrix and the subsequent, timed release of repair chemicals, which resulted in the sealing of matrix cracks, the restoration of strength in damaged areas, and the ability to retard crack propagation. These materials, capable of passive, smart self-repair, comprise several parts:

(1) an agent of internal deterioration that induces cracking, such as dynamic loading,

(2) a stimulus to release the repairing chemical such as the cracking of a fiber,

(3) a fiber,

(4) a repair chemical carried inside the fiber (e.g., either a partial polymer or a monomer), and

(5) a method of hardening the chemical in the matrix in the case of crosslinking polymers, or a method of drying the matrix in the case of a monomer.

It was found that cracking of the repair fiber and subsequent release of the repair chemicals could be achieved. Dry's work is considered by most to be a pioneer in the field of self-healing polymer composites and has paved the way for several other mechanisms of autonomic healing in composites.

Microcracks in engineering materials are common and are often the initial sites of failure of a structure. In composite materials, fatigue and impact damage can lead to matrix cracking and delamination in the material structure, thereby reducing the structural capability of the composite (see, e.g., B. Stavrinidis, D. G. Holloway, “Crack Healing in Glass,” Phys. Chem. Glasses 24, (1983), pp. 19-25). The concept of self-healing composites relies on a healing agent stored in a container that breaks open when damaged.

A breakthrough in the study of self-healing materials was reported in 2001 by a research group at the University of Illinois (see, S. R. White, N. R. Sottos, P. H. Genbelle, J. S. Moore, M. R. Kessler, S. R. Sriram, E. N. Brown, and S. Viswanathan, “Autonomic healing of polymer composites.” Nature 409, pp. 794-797 (2001)). White et al. first introduced the incorporation of microcapsules containing a polymer precursor into the matrix material of a non-fiber reinforced polymer composite for self-healing purposes. The polymer precursor was contained in microcapsules and embedded into the matrix. The matrix contained a randomly dispersed catalyst, which was supposed to react with the precursor flowing through any crack formed due to damage, and initiate polymerization. The polymer was then supposed to bond the crack face closed. The researchers overcame several challenges in developing microcapsules that were weak enough to be ruptured by a crack but strong enough not to break during manufacture of the composite system. The researchers showed that it was possible to recover up to 75% of the maximum tensile strength of the virgin composites.

If successful incorporation of the self-healing material into the fiber reinforced composites (“FRP”) can be achieved, the benefit is quite obvious. Those composites can serve longer with better performance. Self-healing materials embedded in a FRP composite or laminate have shown considerable restoration of mechanical properties, such as flexural strength, compressive strength, impact resistance, and a highly efficient recovery of matrix strength (see, G. Williams, R. S. Trask, and I. P. Bond, “Self-healing sandwich panels: Restoration of compressive strength after impact,” Composites Science and Technology 68, pp. 3171-3177 (2008); and G. Williams, R. S. Trask, and I. P. Bond, “A self-healing carbon fiber reinforced polymer for aerospace application,” Composites 38(6), pp. 1525-1532 (2007)).

However, the properties (especially mechanical properties) of the polymer materials may be degraded when a self-healing system is introduced (see, G. Williams, R. S. Trask, and I. P. Bond, “Self-healing sandwich panels: Restoration of compressive strength after impact,” Composites Science and Technology 68, pp. 3171 -3177 (2008); and G. Williams, R. S. Trask, and I. P. Bond, “A self-healing carbon fiber reinforced polymer for aerospace application,” Composites 38(6), pp. 1525-1532 (2007)). By adding reinforcing ingredients in the polymer material, properties such as mechanical, thermal, and chemical properties can be potentially recovered or even improved.

Embodiments of the present invention introduce self-healing technology (a microencapsulated self-healing agent with catalyst) into a PE matrix to solve the problems previously mentioned. Embodiments of the present invention also improve the mechanical properties of a PE matrix using nanofiller-reinforcement.

A self-healing system utilizing a microencapsulated dicyclopentadiene (“DCPD”) monomer and a solid phase Grubbs's catalyst has been successfully employed in thermosetting polymers (see, S. R. White, N. R. Sottos, P. H. Geubelle, J. S. Moore, M. R. Kessler, S. R. Sriram, E. N. Brown, and S. Viswanathan, “Autonomic healing of polymer composites,” Nature 409, pp. 794-797 (2001)). However, these microcapsules are easily ruptured under stress, force, or pressure. Larger sized microcapsules are especially difficult to handle in such situations without them rupturing. In such situations, the self-healing agent prematurely flows out, rendering the self-healing effect ineffective at a later time when a crack does occur. And, therefore, as a result, self-healing microcapsules have only been used in thermosetting matrixes for self-healing purposes, as the microcapsules are not exposed to the forces that would prematurely rupture them during the thermosetting manufacturing stages.

However, the manufacturing of thermoplastic matrices requires a melt-compounding process, such as an extrusion process, to be utilized. With such processes, the microcapsules will easily rupture, negating any future self-healing properties to be available in the resultant material.

Embodiments of the present invention are able to implement self-healing microcapsules in thermoplastic matrices. The integrity of the microcapsules is preserved if they are of a small enough diameter. It was discovered that an average microcapsule diameter of 50 μm or less allows for the safe manufacture of thermoplastic matrices without prematurely rupturing the self-healing microcapsules. As a result, embodiments of the present invention incorporate such self-healing microcapsules with thermoplastics, such as PE.

In embodiments of the present invention, a microencapsulated dicyclopentadiene (“DCPD”) monomer and a solid phase Grubbs's catalyst is embedded in a PE matrix to achieve self-healing properties.

There are other self-healing systems, such as tin catalyzed polycondensation of silanol functionalized poly(dimethyl siloxane) (“PDMS”), which has very good compatibility with a polymer matrix (see, Michael W. Keller, Scott R. White, and Nancy R. Sottos, “A self-healing poly(dimethyl siloxane) elastomer,” Adv. Funct. Mater. 17, pp. 2399-2404 (2007)). Depending on results, other candidates of a self-healing agent and catalyst may be used for this effort. Microcapsules filled with a self-healing agent may be prepared by an in situ polymerization in an oil-in-water emulsion. The sizes of the microcapsules may be in a range of 5-2000 μm. Smaller microcapsules also have a greater chance of rupturing under stress and therefore healing cracks in a PE matrix.

Additionally, a nanotechnology approach is utilized in embodiments of the present invention to improve the properties of the previously disclosed PE matrix incorporating a self-healing system. Nanocomposites are composite materials that contain particles in the size range of 1-100 nm. These materials bring into play the submicron structural properties of molecules. These particles, such as clay and carbon nanotubes (“CNTs”) (e.g., including single, double, and multiwall carbon nanotubes), generally have excellent physical properties (see, e.g., X. J. He, J. H. Du, Z. Ying, H. M. Cheng, X. J. He, “Positive temperature coefficient effect in multiwalled carbon nanotube/high-density polyethylene composites,” Appl. Phys. Lett 86, 062112 (2005)), including a high aspect ratio and a layered structure that maximizes bonding between the polymer and particles. Functionalized CNTs (such as functionalized with COOH—, NH2—, and/or OH-functional groups) can further improve the properties of the PE matrix. Adding a small quantity of these nanofiller additives (0.5-5%) can increase many of the properties of polymer materials, including higher strength, greater rigidity, higher heat resistance, higher UV resistance, lower water absorption rate, lower gas permeation rate, and other improved properties:

1. The majority of nanofillers, such as nanoclay, ceramic, carbon nanotubes, carbon nanofibers, mineral particles (CaCO₃), and oxide nanoparticles are able to improve the mechanical, properties, such as tensile strength and modulus, of a PE matrix;

2. Carbon nanotubes, carbon nanofibers, carbon black, graphite, and graphene are effective fillers for improving the electrical conductivity of a PE matrix;

3. Carbon nanotubes and carbon black are able to improve the UV damage resistance of a PE matrix;

4. Nanoclay and carbon nanofibers are able to improve the resistance of slow crack growth;

5. Nanoclay, carbon nanofibers, and iron oxide nanoparticles are able to improve the magnetic properties of a PE matrix.

Various combinations of the above-mentioned nanofillers maybe used to co-reinforce a PE matrix. And, furthermore, a melt-compounding (extrusion) process may be used to synthesize PE composites with microcapsules filled with a self-healing agent and such nanofillers. For example, a twin screw extruder may be used to blend PE pellets with self-healing microcapsules and the corresponding catalyst, and, optionally, any one or more of the above-disclosed nanofillers. Following are parameters used in an exemplary process. However, these parameters may be customized to achieve desired final results.

Screw zone 1 temperature—160°C.;

Screw zone 2 temperature—180° C.;

Screw zone 3 temperature—180° C.;

Die temperature—180° C.

Screw speed—Approximately 100 rpm.

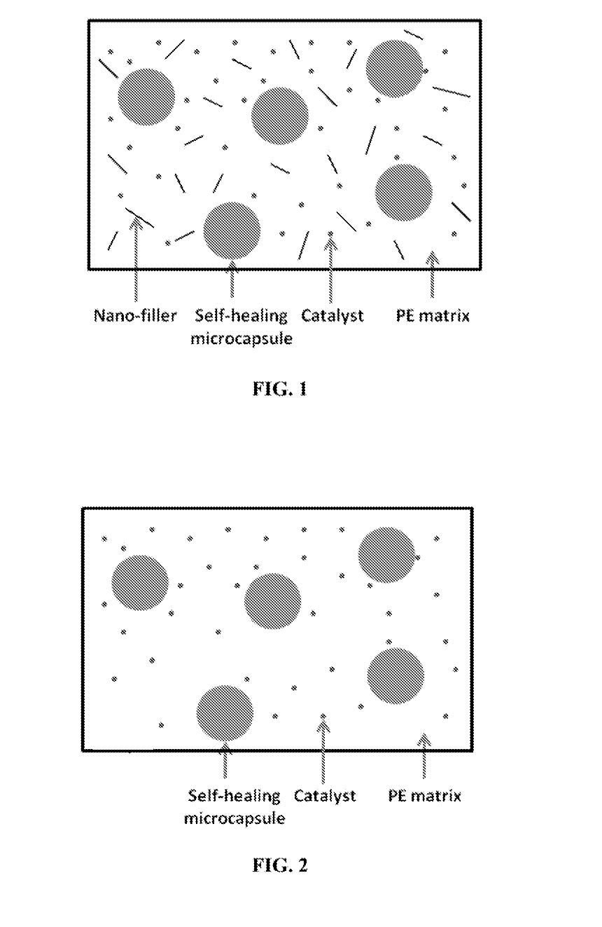

FIG. 1 schematically illustrates a PE matrix manufactured to include self-healing microcapsules, an. appropriate catalyst for the self-healing microcapsules, and one or more of any of the nanofillers disclosed herein.

FIG. 2 schematically illustrates a PE matrix manufactured to include self-healing microcapsules and an appropriate catalyst for the self-healing microcapsules, but without any additional nanofillers.

What is claimed is:

1. A composite material comprising a polyethylene matrix and a self-healing system.

2. The composite material as recited in claim 1, wherein the polyethylene matrix comprises a medium or high density polyethylene.

3. The composite material as recited in claim 1, wherein the self-healing system is a microencapsulated dicyclopentadiene monomer and a solid phase Grubbs's catalyst.

4. The composite material as recited in claim 1, wherein the self-healing system is a microencapsulated tin catalyzed polycondensation of silanol functionalized poly(dimethyl siloxane).

5. The composite material as recited in claim 1, further comprising a nanofiller.

6. The composite material as recited in claim 1, wherein the nanofiller is carbon nanotubes.

7. The composite material as recited in claim 1, wherein the nanofiller is clay.

8. The composite material as recited in claim 1, wherein the nanofiller is grapheme.

9. The composite material as recited in claim 1, wherein the nanofiller is graphite.

10. The composite material as recited in claim 1, wherein the nanofiller is carbon black.

11. The composite material as recited in claim 1, wherein the nanofiller is ceramic particles.

12. The composite material as recited in claim 1, wherein the nanofiller is carbon nanofiber.

13. The composite material as recited in claim 1, wherein the nanofiller is oxide particles.

14. The composite material as recited in claim 1, wherein the nanofiller is mineral particles.

15. The composite material as recited in claim 6, wherein the carbon nanotubes are functionalized carbon nanotubes.

16. The composite material as recited in claim 3, further comprising a nanofiller.

17. The composite material as recited in claim 1, wherein the self-healing system is suitable for rupturing and filling in a crack formed in the composite material.

18. The composite material as recited in claim 1, wherein an average size of microcapsules in the self-healing system is less than 50 microns.

19. The composite material as recited in claim 1, wherein the composite material is a thermoplastic material.

20. The composite material as recited in claim 18, wherein an average size of microcapsules in the self-healing system is less than 50 microns.
